(19) United States
(12) Patent Application Publication
(10) Pub. No.: US 2004/0010625 A1
(43) Pub. Date: Jan. 15, 2004

(54) Interface device and method for transferring data over serial ATA

(75) Inventors: Lih-Shang Lo, Jubei City (TW); Chuan Liu, Tainan Hsien (TW)

Correspondence Address: MERCHANT & GOULD PC, P.O. BOX 2903, MINNEAPOLIS, MN, 55402-0903, US

(73) Assignee: Silicon Integrated Systems Corp.

(21) Appl. No.: 10/191,213

(22) Filed: Jul. 9, 2002

(51) Int. Cl. G06F 15/16

(52) U.S. Cl. 709/250

(57) ABSTRACT

An interface device for the synchronous transfer of data over serial ATA. The link layer portion receives the data from a device. The status monitor detects the status of the link layer portion. The fix pattern generator provides primitive formats responding to the status of the link layer portion. The physical layer controller directly returns the primitive formats to the device without sending or receiving the primitive formats to the link layer portion.

### BACKGROUND OF THE INVENTION

1. Field of the Invention

The present invention relates in general to an interface device and a method to improve the transmission rate over serial ATA. In particular, the present invention relates to an interface device and a method to minimize handshake latency over serial ATA.

2.Description of the Related Art

The ATA interface evolved from the Advanced Technology (AT) interface developed originally for the IBM® PC/AT computer in the mid-1980s. However, it wasn't until the late 1980s that the implementation of the ATA interface as we recognize it today was developed. The modern ATA interface is the result of collaborative efforts by Imprimis Division of Control Data Corporation (CDC), Western Digital Corporation, and Compaq Computer Corporation. These companies combined elements of the original AT interface with HDD and controller electronics to produce the first integrated ATA interface.

Introduced in the 1980s, the Parallel ATA interface has been the dominant PC storage interface protocol for desktop and portable computers. Parallel ATA's relative simplicity, high performance, and low cost have enabled it to meet and maintain the cost/performance ratio that is essential in the mainstream desktop and portable computer systems market.

However, the Parallel ATA interface has a long history of design issues, which are 5-volt signaling requirement, data robustness, and cable issues.

Serial ATA is expected to eliminate the limitations of the current Parallel ATA interface. Because the Serial ATA architecture changes the physical interface layer only, it maintains register compatibility and software compatibility with Parallel ATA. No device driver changes are necessary and the Serial ATA architecture is transparent to the BIOS and the operating system.

Third-generation Serial ATA supports data transfer rates of up to 600 MB/sec. The physical layer of serial ATA must perform at a very high-speed clock rate to send out the data serially. The link and above layers, however, do not. In this situation, well-designed synchronization is required between link layer and physical layer. The serial ATA host and device communicate via handshake protocol and need many clock periods for command transfer between link layer and physical layer because of the synchronization.

FIG. 1 shows a conventional command shadow register transmission. In time slot 3, link layer is ready to send shadow register block. Because of synchronization between link layer and physical layer, physical layer sends XRDY primitive at time slot 6, and here assumes 3 clock periods for synchronization. The link layer of the device indicates ready to receive in time slot 9 and sends RRDY primitive out. Then, the physical layer of the device sees RRDY primitive at time 12 because of synchronization latency. The link layer of host receives this primitive at time slot 16. Then host decodes R_RDY and starts a frame by sending SOF at time slot 17 and a transmission begins.

In this example, it is obvious that longtime latency exists between link layer and physical layer when sending and receiving primitives in each transmission. Moreover, in the link receive state in the conventional protocol, link layer sends R_OK or R_ERR until a SYNC primitive is received and then ends this transition as shown in FIG. 2, then, the link layer to prepare the next transmission. Thus, the transfer rate in conventional serial ATA is degraded.

### SUMMARY OF THE INVENTION

The object of the present invention is to provide an interface device and a method to decreases the handshake latency time between the device and the link layer state machine of the host or the host and the link layer state machine of the device over serial ATA.

Moreover, another object of the present invention is to provide a method to improve the transfer rate of a transmission over serial ATA.

To achieve the above-mentioned object, the present invention provides an interface device for the synchronous transfer of data over serial ATA. The link layer portion receives the data from a device. The status monitor detects the status of the link layer portion. The fix pattern generator for providing primitive formats responds to the status of the link layer portion. The physical layer controller directly returns the primitive formats to the device without sending or receiving the primitive formats to the link layer portion.

Moreover, the present invention provides a method for the synchronous transfer of data from a data source to a receiving device. The receiving device comprises a link layer portion having a predetermined status to receive the data and a physical layer portion with a different operating frequency. First, the predetermined status of the link layer portion is detected. Then, the physical layer portion generates the patterns responding to the detected predetermined status of the link layer portion. Finally, the physical layer portion returns the patterns to the data source to indicate that the receiving device is ready to receive data.

Moreover, the present invention provides an interface device for the synchronous transfer of data over serial ATA. The data source provides the data, and the receiving device receives the data and returns confirmation to indicate that the data is received. It then enters an idle state without waiting for a command from the data source after returning the confirmation to the data source a predetermined number of times.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a conventional command shadow register transmission.

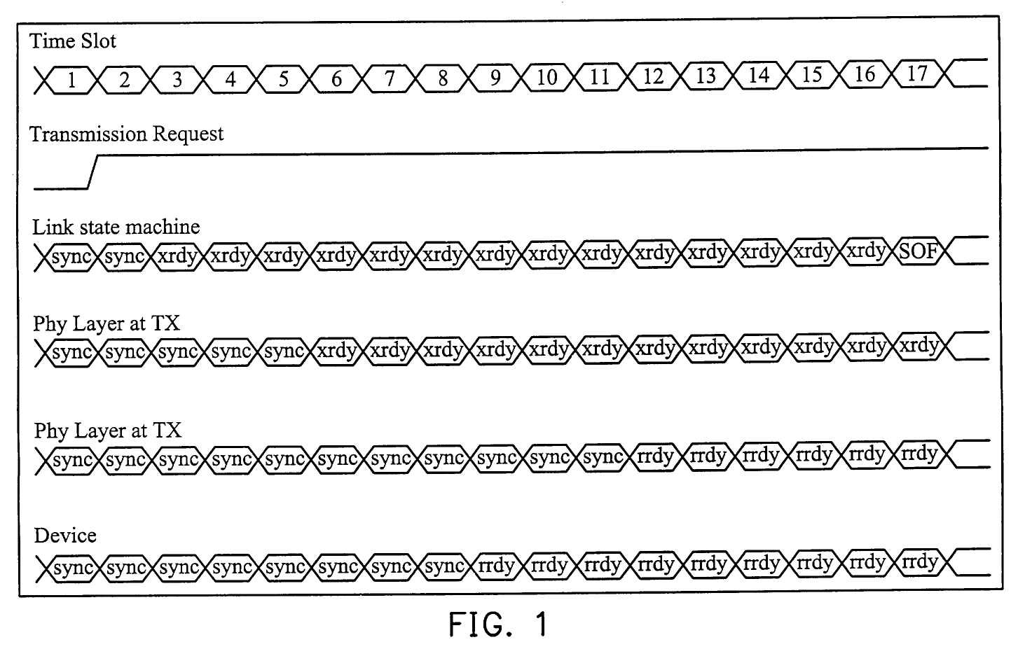

FIG. 2 shows another conventional command shadow register transmission.

FIG. 3 is a block diagram of the interface device according to the embodiment of the present invention.

FIG. 4 shows a command shadow register transmission according to the embodiment of the present invention.

FIG. 5 shows another command shadow register transmission according to the embodiment of the present invention.

### DETAILED DESCRIPTION OF THE INVENTION

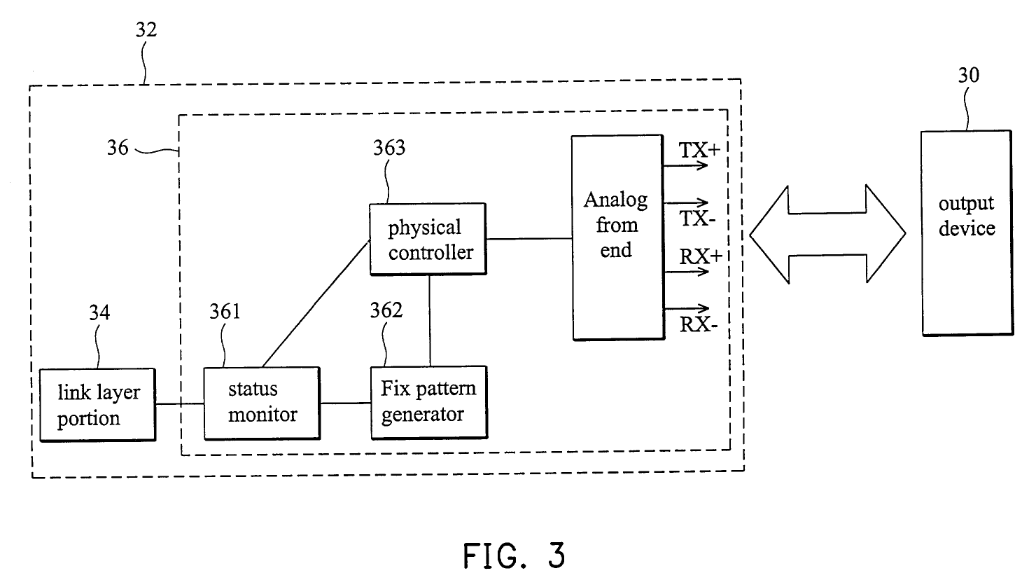

FIG. 3 is a block diagram of the interface device according to the embodiment of the present invention. The interface device is used for the synchronous transfer of data over serial ATA. There are two devices for receiving and transferring data, and the output device 30 outputs the data and the host 32 receives the data. Both comprise a link layer portion and physical layer portion respectively. The operation frequencies between the link layer portion and the physical layer portion are very different. FIG. 3 only shows the link layer portion 34 and the physical layer portion 36 of the host 32, but the output device 30 comprises the same structure. The link layer portion 34 of host 32 receives the data from the device 30. The data transferred between the link layer and the physical layer is in parallel form, and the data transferred between the physical layers of the host 32 and the output device 30 is in serial form.

At this time, the link layer portion 34 generates some primitives indicating the state of the layer portion 34 by link state machine. The status monitor 361 continues to detect the status of the link layer portion 34. The fix pattern generator 362 generates primitive formats responding to the status of the link layer portion 34 detected by the status monitor 361, such as XRDY and RRDY. The physical layer controller 363 directly returns the primitive formats to the device 30 without receiving the primitive formats to the link layer portion.

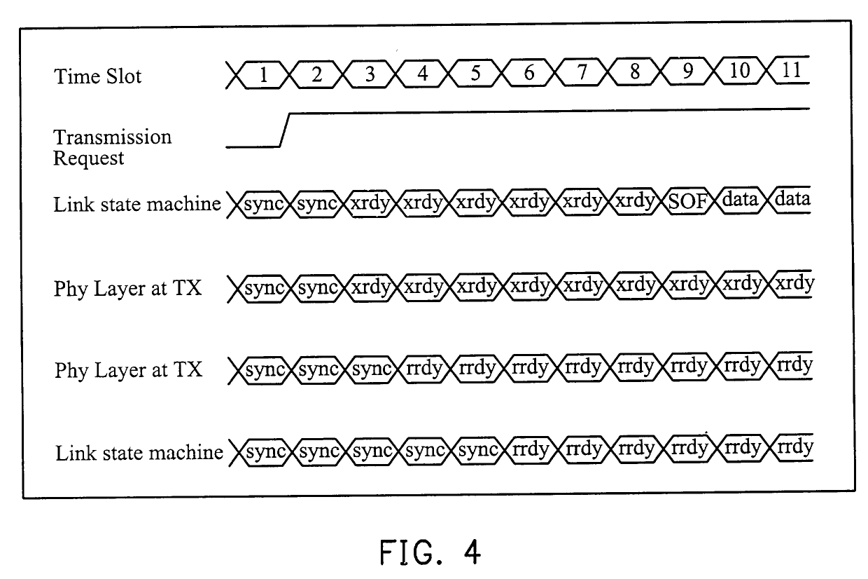

FIG. 4 shows a command shadow register transmission according to the embodiment of the present invention. In time slot 2, link layer is ready to send shadow register block. Because the status monitor 361 and fix pattern generator 362 are in the physical layer portion 36, physical layer portion 36 can send XRDY primitive out in time slot 3. In time slot 6, the physical layer portion of the device 30 sees XRDY primitive and also because of the status monitor and fix pattern generator of the device 30 are all in the physical layer, the device 30 is able to receive and the physical layer of the device 30 sends RRDY primitive out and also sends receive data to link layer portion of the device 30. In time slot 7, the physical layer portion 36 of host 32 receives the RRDY primitive and the link layer potion 34 starts a frame by sending SOF at time slot 11 and a transmission begins.

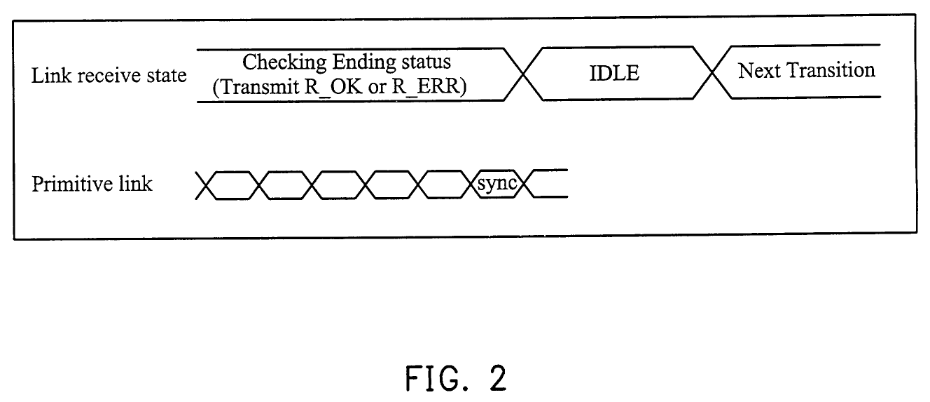

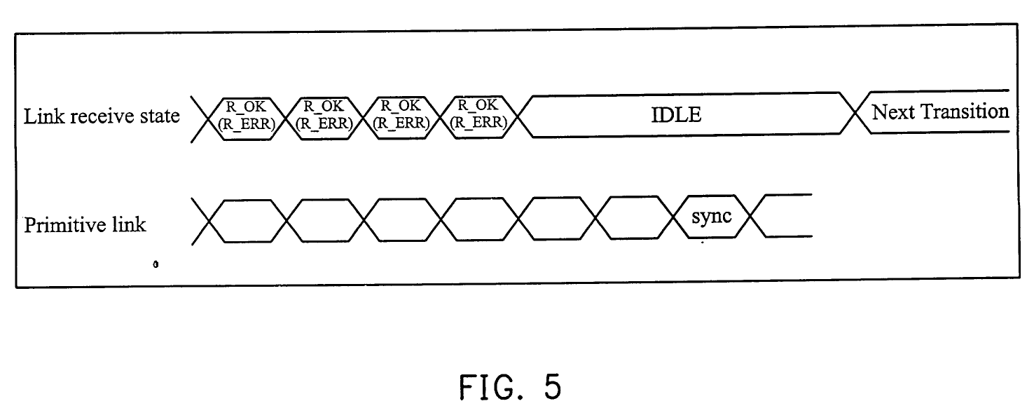

Moreover, as mentioned above, in the link receive state in conventional protocol, link layer sends R_OK or R_ERR to indicate successful data receipt or not until a SYNC primitive is received, which means that the output device finishes sending the data out, and then ends this transition as shown in FIG. 2. In the present invention, the link layer portion needs only send some primitives back a predetermined number of times. The device detects the primitives without fail. Usually, four or five predetermined times is sufficient. Thus, the link layer portion only needs to send 4 primitives and then goes to idle state to prepare the next transition as shown in FIG. 5. Thus, in a busy transition, the method according to the embodiment of the present invention will effectively decrease transition time and increase performance when there are a lot of transition events.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for the synchronous transfer of data from a data source to a receiving device comprising a link layer portion having a predetermined status for receiving the data and a physical layer portion with different operating frequency, the method comprising the following steps:
detecting the predetermined status of the link layer portion;
generating patterns responding to the predetermined status of the link layer portion on the physical layer portion; and
returning the patterns to the data source from the physical layer portion to indicate that the receiving device is ready to receive data.

2. The method as claimed in claim 1, wherein the link layer portion transfers parallel data to the physical layer portion.

3. The method as claimed in claim 1, wherein the physical layer portion transfers serial data to the receiving device.

4. An interface device for the synchronous transfer of data over serial ATA, comprising:
a link layer portion for receiving the data from a device;
a status monitor for detecting the status of the link layer portion;
a fix pattern generator for providing primitive formats responding to the status of the link layer portion; and
a physical layer controller for directly returning the primitive formats to the device without receiving the primitive formats to the link layer portion.

5. An interface device for the synchronous transfer of data over serial ATA, comprising:
a data source for providing the data; and
a device for receiving the data from the data source and returning confirmation that the data is received, then entering an idle state without waiting for a command from the data source after returning the confirmation to the data source a predetermined number of times.

6. The interface device as claimed in claim 5, wherein the data source transfers serial data to the receiving device.

7. The interface device as claimed in claim 5, wherein the predetermined number of times is at least two.
